(19) United States
(12) Patent Application Publication
(10) Pub. No.: US 2002/0163539 A1
(43) Pub. Date: Nov. 7, 2002

(54) Sharing information from a computer mail-box

(76) Inventor: Arvind Srinivasan, Mountain View, CA (US)

Correspondence Address: THEODORE JAY, 16 N CHATSWORTH AVE, APT 600, LARCHMONT, NY, 10538, US

(21) Appl. No.: 09/898,159

(22) Filed: Jul. 3, 2001

Related U.S. Application Data
(60) Provisional application No. 60/288,639, filed on May 4, 2001.

(51) Int. Cl. G06F 3/00; G06F 13/00

(52) U.S. Cl. 345/752

(57) ABSTRACT

A method for an owner to own and use a computer mail-box in storing and selectively transmitting mails from a user, who may or may not be an originating user, to a destination user. The method includes using the mail-box as a functional interface that enables mails to be displayed, sorted, altered, rearranged, deleted and catalogued therein; storing the mails in folders; identifying certain specific folders as Inbox, Send Items and Trash; and sharing by the owner messages, folders, portions of the mail-box or even the entire mail-box with specific other users.

### CROSS REFERENCE TO PENDING APPLICATION

The present invention is a continuation in part of copending provisional application of Arvind Srinivasan entitled Sharing Information From A Mail-Box Ser. No. 60/288,639 having a filing date of May 4, 2001.

### BACKGROUND OF THE INVENTION

A computer mail-box is defined as a private virtual storage space in a computer which is controlled by an owner for the purpose of storing and selectively transmitting mails from a user, who may or not be an originating user, to a destination user. A mail is any information, thought or idea expressed in plain or encrypted computer format for storage and/or transmission. An originating user is a user initiating a mail transfer and a destination user is the one for whom the mail is intended. The originating user can also to the destination user. The owner and all users have email access to the computer. Only the owner has the authority to define and authorize email access rights of users to the entire mail-box.

A mail-box provides a functional interface that enables mails to be displayed, sorted, altered, rearranged, deleted and catalogued. Users authorized by the owner can receive and respond to such mails. The mails are usually stored in folders. Folders are normally user defined except for certain folders specifically defined as Inbox, Send Items and Trash respectively. Inbox folders normally consist of mails received by the user. The folders in Sent Items normally comprise mails sent by the mail-box user to other users. Trash folders contain mails that have been deleted by a mail-box user.

The mails in each of these folders can be sorted, deleted or rearranged into other folders depending upon the user's desire. These mails may be sorted based on various criteria including but not limited to the originating user, date or the subject of the mail.

### SUMMARY OF THE INVENTION

In accordance with the principles of this invention, the owner can share messages, folders, or a portion of the mail-box or indeed, the entire mail-box with specific other users. The owner has the authority to describe the access rights to his entire mail-box or parts therein. The owner also has access to information on parties accessing his mail-box.

In order for the owner to share his messages with other users, he becomes an originating user and has a list of all potential users and can share messages/folders with the selected user or users. He specifies the user with whom he wishes to share his message/folder. He can enter the email address of the selected user if it is not known to the system or enter the knickname of the user if the user is listed in his address book. He can specify the permission or permissions he grants to the user in his sharing action. He can give the user or users authority to read, respond or receive complete control over the message/folder and can limit this authority for a specified limited time period.

If the owner desires to grant access to a group of selected users or to an entire domain he may do so for a limited or unlimited period. The owner then starts the sharing software which then arranges for a URL [universal resource indicator] to be created and mailed to each of the selected users specified. Each recipient can then click on the URL to obtain the desired access or can store it for future use.

In this manner, the owner can share his messages, folders or his entire mail-box with various other parties for specific durations with specified privileges. This arrangement enhances the ability to share information and increases collaboration at both a personal lever as well as at a corporate level ensuring optimum security.

The invention will now be explained in more detail with reference to the drawings and detailed description which follow.

### BRIEF DESCRIPTION OF THE DRAWINGS

FIG. 1 illustrates the creation of a mail-box.

FIG. 2 illustrates a mail-box owned by John Doe.

FIG. 3 illustrates Ziplip's email sending/receiving architecture.

FIG. 4 illustrates the sharing action of John Doe's selected folders with selected users.

FIG. 5 illustrates the sending of a URL to selected users after John Doe has initiated the sharing software.

FIG. 6 illustrates John Doe's sharing his folders with another user having its own mail-box.

FIG. 7 illustrates access to John Doe's folder.

FIG. 8 is a flow chart of the entire process.

### DETAILED DESCRIPTION OF PREFERRED EMBODIMENTS

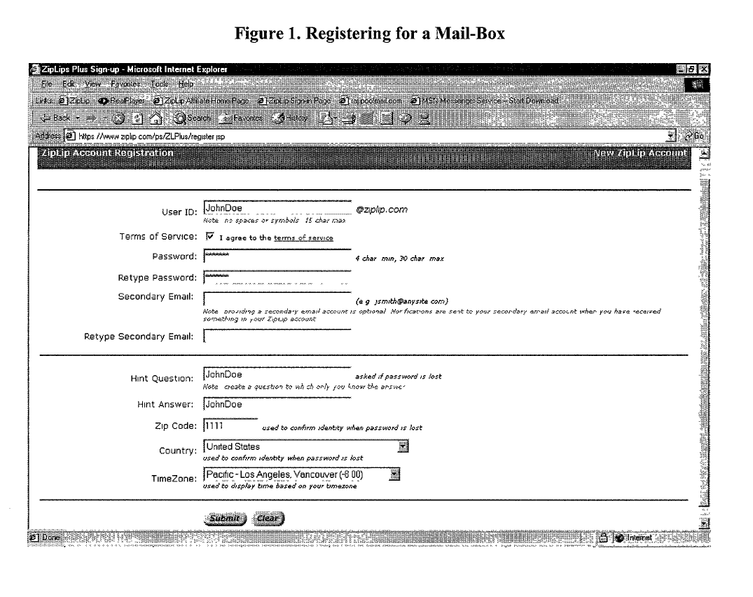

As shown in FIG. 1, a creation of a mail-box begins when an owner, an originating user, registers for an email account with Ziplip. To do so, he clicks on the link register. Upon entering the appropriate information, an account is automatically created with the userid [user identification] and password of the user's choice. At the time of creation, the system automatically provides this user with a certain amount of virtual private space to store his messages. The system also creates the four standard folders, namely Inbox, Sent, Drafts and Trash and the mail-box formation is complete.

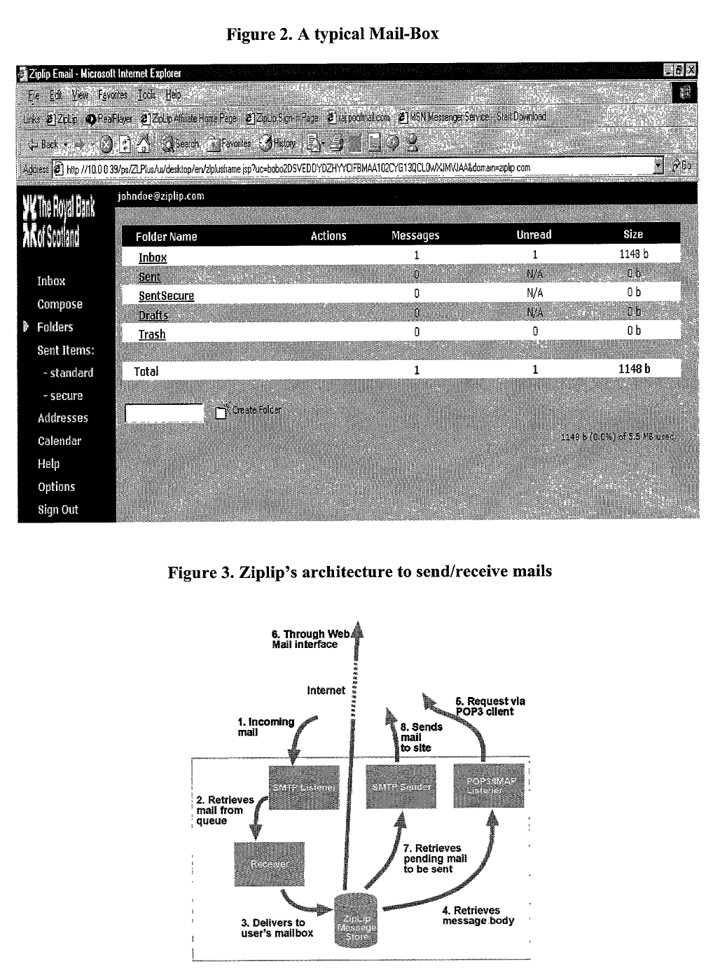

When the originating user enters the correct userid and password, he is given access to the newly formed mail-box. The user can begin its use. The user may take various steps such as customizing the account, change various particulars, create new folders, and the like. FIG. 2 illustrates a typical mail-box.

The system architecture is illustrated in FIG. 3. The system generates an email address for the user which is based on his userid and creates a virtual communication channel through the internet for the user to send and receive emails.

The sharing software presents the user with the unique opportunity to share messages, folders or the entire mail-box with other users. The user clicks on the appropriate message/folder and starts the sharing software. To do so, the user clicks on the selected message/folder and selects sharing as an option.

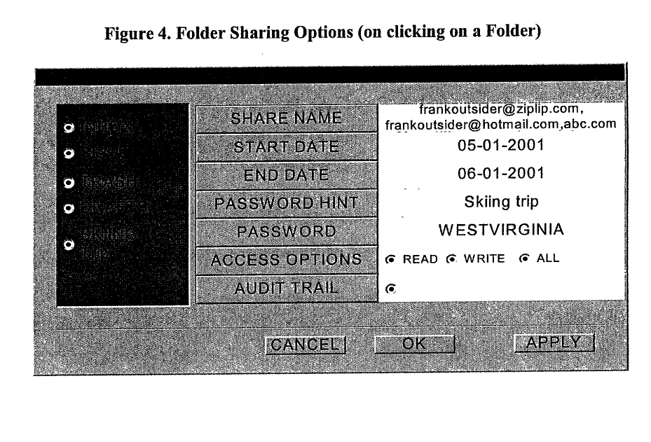

FIG. 4 illustrates the different sharing options that the software provides. The user specifies the user[s] he wishes to share the selected message/folder with. To do so, the user may enter the email address of the user, or the name if the user exists in his address book. The user may choose an entire domain if he so wishes. The owner also specifies the duration for which this permission is granted. The user then creates a password for this message/folder.

The owner then specifies the permissions he would like to grant other parties. He could give the parties authority to read, write or grant complete control over the message/folder. The owner may also want to conduct audit trails to track information regarding the time and duration of user access.

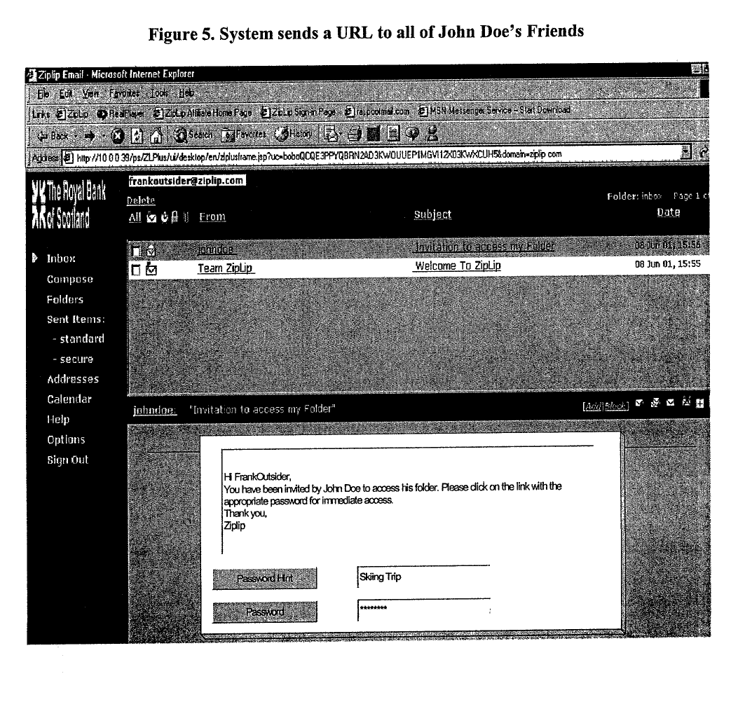

Once the sharing software is activated, the system generates a URL and sends it to all the concerned parties informing them of their access rights. FIG. 5 illustrates the URL that the system sends to all the parties. The URL provides the exact location at which the message/folders are present. The other parties may enter the appropriate password and access the message/folder immediately or they may save the URL for later access.

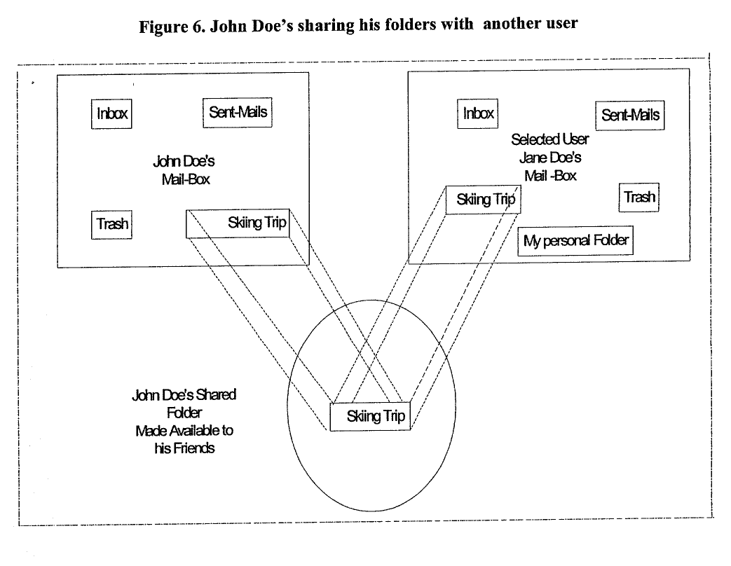

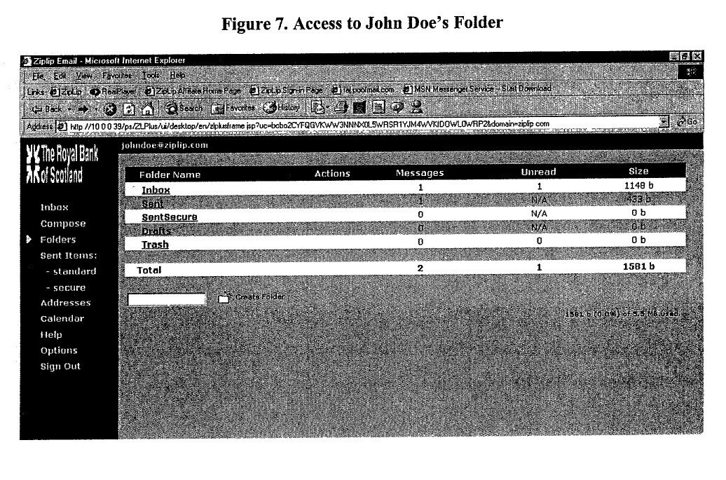

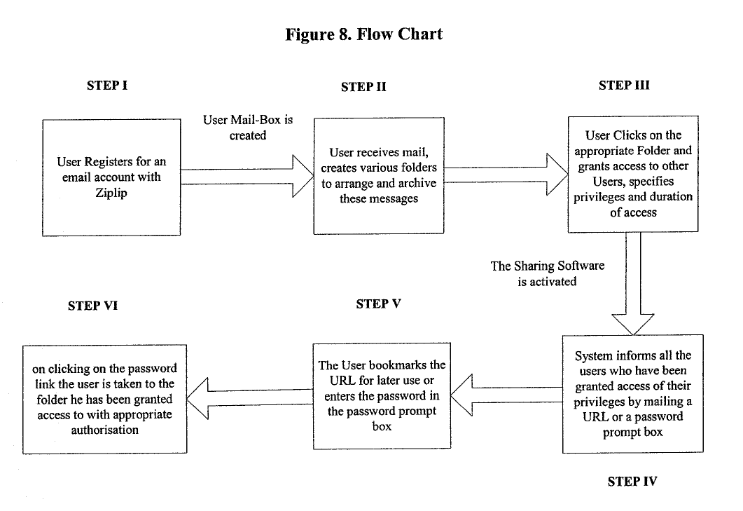

FIG. 6 illustrates the sharing of these message folders with other parties. FIG. 7 illustrates the access to the owner's mail-box. FIG. 8 illustrates the entire flow chart.

Once the other parties access the message/folder, the user may track the time and duration of this access at any time.

While the invention has been described with particular reference to the drawings and detailed description, the protection solicited is to be limited only by the terms of the claims which follow.

What is claimed is:

1. A method for an owner to own and use a computer mail-box in storing and selectively transmitting mails from a user, who may or may not be an originating user, to a destination user, said method comprising:
using the mail-box as a functional interface that enables mails to be displayed, sorted, altered, rearranged, deleted and catalogued therein;
storing said mails in folders;
identifying certain specific folders as Inbox, Send Items and Trash; and
sharing by the owner messages, folders, portions of the mail-box or even the entire mail-box with specific other users.

2. The method of claim 1 wherein the owner has authority to describe the access rights to his entire mail-box or parts thereof.

3. The method of claim 2 wherein the owner has access to information on parties accessing his mail-box.

4. The method of claim 3 wherein the owner, in order to share his messages with other users, becomes an originating user and has a list of all potential users with whom he can share messages/folders.

5. The method of claim 4 wherein the owner can give the user or users authority to read, respond or receive complete control over the message/folder and limit this authority for a specified limited time period.
